(19) United States
(12) Patent Application Publication
(10) Pub. No.: US 2013/0008294 A1
(43) Pub. Date: Jan. 10, 2013

(54) SHEET PROCESSING APPARATUS AND SHEET CONVEYING METHOD

(75) Inventors: Hiroyuki TAGUCHI, Shizuoka (JP); Hidetoshi YOKOCHI, Shizuoka (JP)

(73) Assignees: Toshiba Tec Kabushiki Kaisha, Tokyo (JP); Kabushiki Kaisha Toshiba, Tokyo (JP)

(21) Appl. No.: 13/403,770

(22) Filed: Feb. 23, 2012

Related U.S. Application Data
(60) Provisional application No. 61/505,062, filed on Jul. 6, 2011.
(60) Provisional application No. 61/505,063, filed on Jul. 6, 2011.

(51) Int. Cl. B26D 5/02; B65H 5/00; B26D 5/20

(52) U.S. Cl. 83/368; 271/264

(57) ABSTRACT

If a sheet processing apparatus does not perform a punching action, the sheet processing apparatus displaces, (1) if conveying speed of a sheet exceeds a threshold, a punch unit such that a width direction perpendicular to a sheet conveying direction of a skew detecting section, which is a conveyance guide rear end of the sheet, and the center line in the width direction of the punch unit are parallel to each other and displaces, (2) if the conveying speed of the sheet equal to or lower than the threshold, the punch unit according to movement of the sheet.

### CROSS-REFERENCE TO RELATED APPLICATIONS

This application is based upon and claims the benefit of priority from the prior the U.S.A. Patent Application No. 61/505,062, filed on Jul. 6, 2011, and the prior the U.S. Patent Application No. 61/505,063, filed on Jul. 6, 2011, and the entire contents of which are incorporated herein by reference.

### FIELD

Embodiments described herein relate generally to a sheet processing apparatus and a sheet conveying method.

### BACKGROUND

An image forming apparatus such as a copying machine sometimes includes, between the image forming apparatus and a finishing apparatus, a punching apparatus that applies punching to sheets.

The punching apparatus displaces a punching mechanism according to a skew, i.e., a lateral shift of a sheet conveyed from the image forming apparatus. It is possible to apply punching in an appropriate place even to a skewed sheet according to the displacement of the punching mechanism.

To displace the punching mechanism, a space for the displacement is necessary. When a curl occurs in a sheet, the leading end of the sheet enters the space and causes a bend.

Therefore, there is a demand for a sheet processing apparatus and a sheet conveying method that less easily cause a bend of a sheet.

### BRIEF DESCRIPTION OF THE DRAWINGS

FIG. 1 is a diagram of the configuration of an image forming apparatus;

FIG. 2 is a perspective view of a main part of a punch unit;

FIG. 3 is a plan view of the main part of the punch unit;

FIG. 4 is a block diagram of the configurations of an image forming apparatus and a punching apparatus;

FIG. 5 is a diagram of a state in which the punch unit is present in a home position;

FIG. 6 is a diagram of a position where the punch unit is located when the conveying speed of a sheet is higher than a threshold;

FIG. 7 is a diagram of a position where the punch unit is located when the conveying speed of the sheet is equal to or lower than the threshold;

FIG. 8 is a diagram of a state of displacement of the punch unit; and

FIG. 9 is a flowchart for explaining the operation of a punching apparatus.

### DETAILED DESCRIPTION

Throughout this description, the embodiments and examples shown should be considered as exemplars, rather than limitations on the apparatus and methods of the present invention.

A sheet processing apparatus and a sheet conveying method according to an exemplary embodiment are explained in detail below with reference to the accompanying drawings. Examples of the image forming apparatus include a copying machine, an MFP (Multifunction Peripheral), and a printer.

The sheet processing apparatus according to this embodiment includes: a punch unit including a punch head for perforating a sheet; a driving unit configured to Pivot the punch unit in a pivoting direction along a sheet conveying direction; a conveyance guide arranged downstream in the sheet conveying direction of the punch unit and adjacent to a position for not preventing the movement of the punch unit and configured to guide the sheet to be conveyed; and a control section configured to move, if the sheet is not perforated, with the driving unit, the punch unit to a position where the center line in the width direction of the punch unit and the width direction of the conveyance guide are parallel to each other and put the punch unit on standby before the sheet is conveyed.

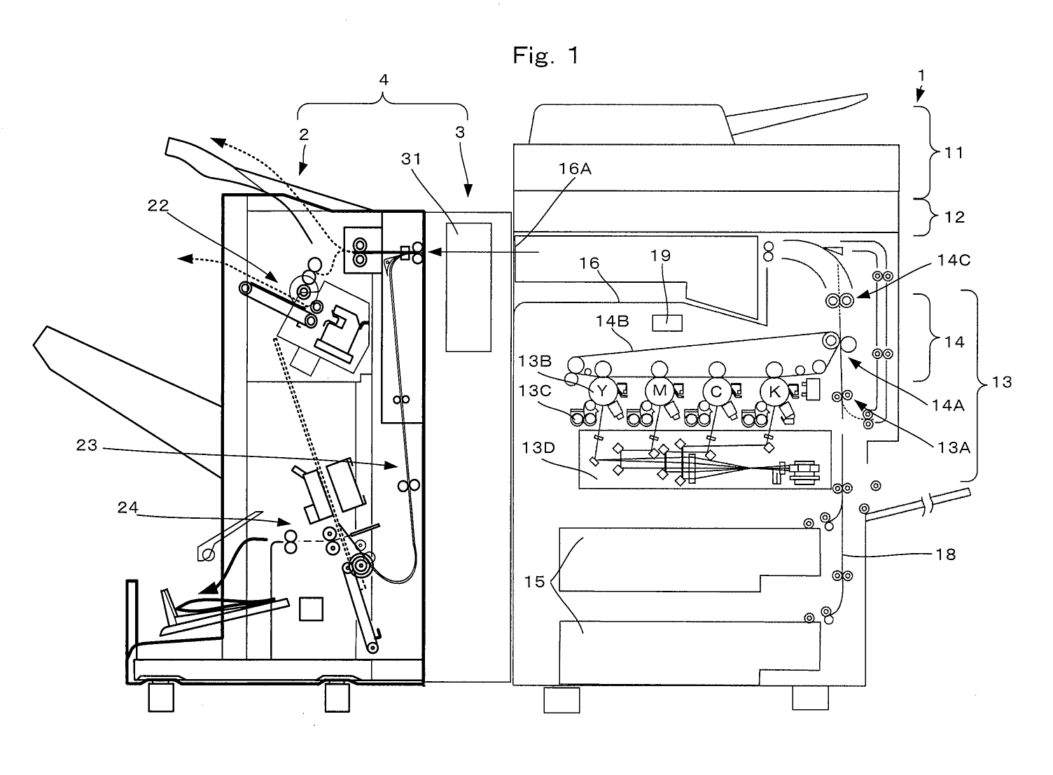

FIG. 1 is a diagram of the configuration of an image forming apparatus 1 according to this embodiment. As shown in FIG. 1, the image forming apparatus 1 includes an auto document feeder 11, an image reading section 12, an image forming section 13, a paper feeding unit 15, a sheet conveying mechanism 18, and a control section 19.

The auto document feeder 11 is openably and closably set in an upper part of a main body of the image forming apparatus 1. The auto document feeder 11 extracts original documents from a paper feeding tray one by one and conveys the original document to a document reading position of the image reading section 12. The image reading section 12 reads an image of the original document conveyed by the auto document feeder 11. If the auto document feeder 11 is pivoted upward, the image reading section 12 may read an original document placed on a placing table by a user.

The image reading section 12 includes a carriage including an exposure lamp for exposing an original document to light and a first reflection mirror, plural second reflection mirrors that move according to the movement of the carriage, a lens block, and a CCD (Charge Coupled Device) of an image reading sensor.

The carriage stands still in the document reading section or reciprocatingly moves under a document table and reflects the light of the exposure lamp, which is reflected by the original document, to the first reflection mirror. The plural second reflection mirrors reflect the reflected light of the first reflection mirror to the lens block. The lens block changes the magnification of the reflected light and outputs the reflected light to the CCD. The CCD converts the incident light into an electric signal and outputs the electric signal to the image forming section 13 as an image signal.

The image forming section 13 includes a registration roller 13A that corrects the direction of an obliquely conveyed sheet such that sides in the width direction of the sheet are parallel to a sheet conveying direction.

The image forming apparatus 1 forms an image on the sheet, the direction of which is corrected by the registration roller 13A, with the image forming section 13.

An image forming method of the image forming section 13 may be any method. The image forming method of the image forming section 13 can be selected from systems such as an electronic system and an inkjet system.

In the case of the electronic system, the image forming section 13 includes, for each of yellow Y, magenta M, cyan C, and black K, a laser irradiating unit 13D, a photoconductive drum 13B functioning as an electrostatic latent image bearing member, a developer supplying unit 13C, and a transfer section 14.

The laser irradiating unit 13D irradiates a laser beam on the photoconductive drum 13B on the basis of an image signal and forms an electrostatic latent image on the photoconductive drum 13B. The developer supplying unit 13C supplies a developer to the photoconductive drum 13B and forms a developer image from the electrostatic latent image.

The paper feeding unit 15 extracts sheets from a paper feeding cassette one by one and passes the sheet to the sheet conveying mechanism 18. The sheet conveying mechanism 18 conveys the sheet to the transfer section 14.

The transfer section 14 includes a transfer belt 14B and a transfer roller 14A. The transfer belt 14B functioning as an image bearing member receives the transfer of the developer image from the photoconductive drum 13B and bears the developer image. The transfer roller 14A applies a voltage to the developer image on the transfer belt 14B and transfers the developer image of the transfer belt onto the conveyed sheet.

The image forming apparatus 1 includes a fixing device 14C downstream in the sheet conveying direction of the transfer section 14. The fixing device 14C heats and presses the developer image and fixes the developer image on the sheet.

In the case of the inkjet system, the image forming section 13 includes a head for spraying ink to a sheet.

The head includes an ink supply chamber in which piezoelectric elements having different polarities are stuck in a longitudinal direction and sets of the stuck piezoelectric elements are arranged in a comb teeth shape and a cover that includes ink ejection holes and covers the ink supply chamber. The image forming section 13 alternately applies voltages to the head to thereby deform the ink supply chamber and repeats suction of the ink and ejection of the ink from the ink ejection holes. The ejected ink adheres to a sheet and image formation is performed.

A sheet processing apparatus 4 includes a finishing apparatus 2 and a punching apparatus 3. The finishing apparatus 2 includes a sheet conveying mechanism 23 that conveys a sheet, a stapling unit 22 that accumulates a predetermined number of sheets and staples the sheets, and a saddle-folding unit 24 that saddle-folds the sheets.

The sheet processing apparatus 4 is set adjacent to a sheet discharge section 16A of the image forming apparatus 1 for discharging a sheet on which an image is formed. The punching apparatus 3 includes a punch unit 31 that applies punching to the sheet received from the image forming apparatus 1. The punching apparatus 3 applies punching to the sheet or does not apply punching to the sheet and passes the sheet to the finishing apparatus 2 provided next to the punching apparatus 3.

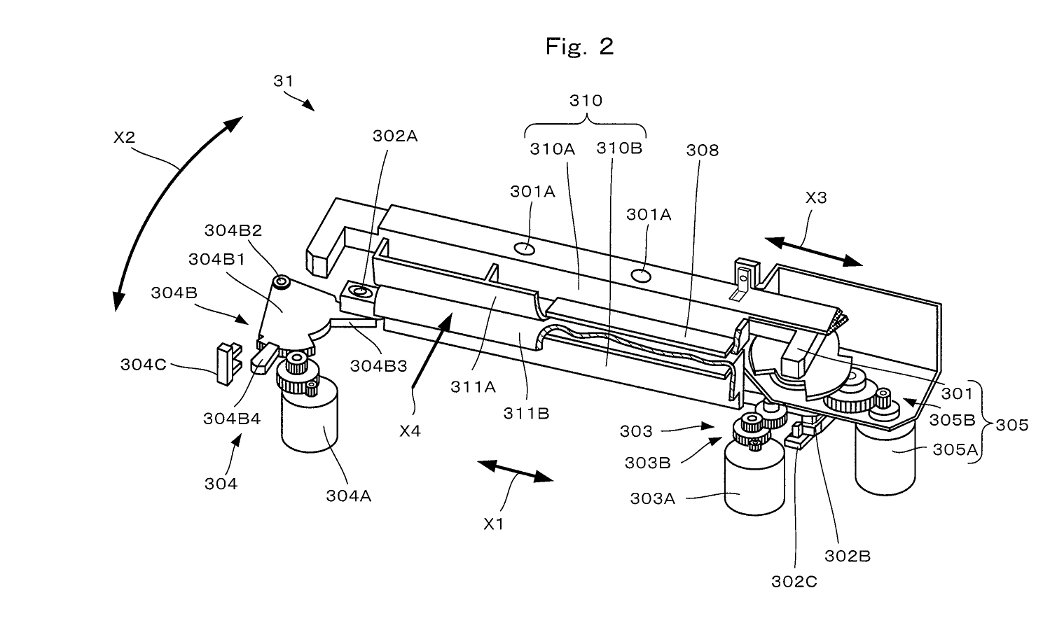

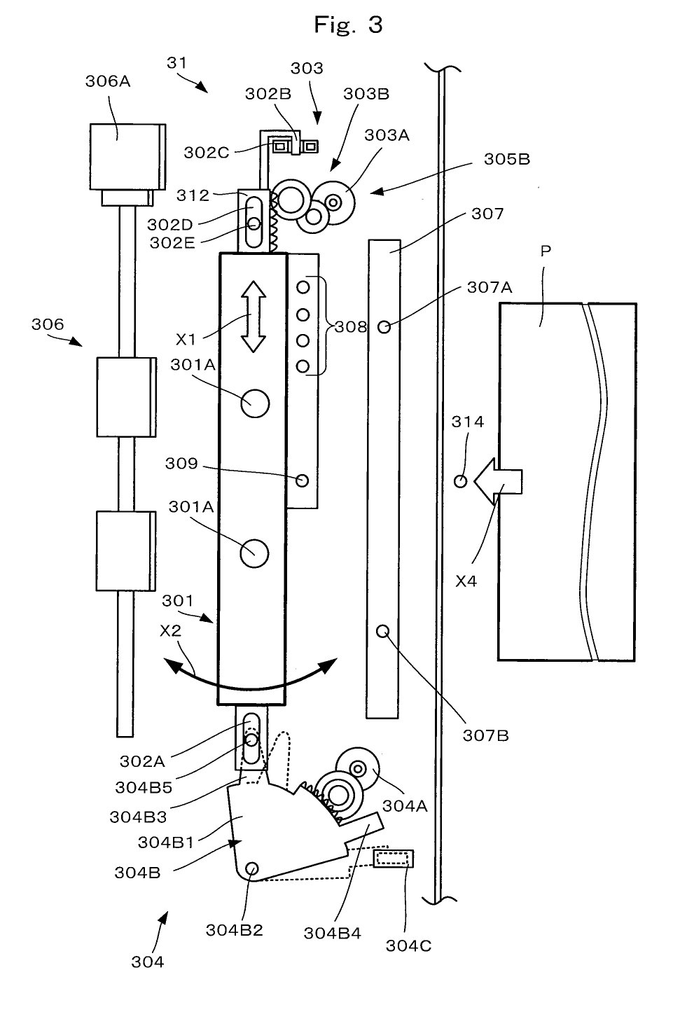

FIG. 2 is a perspective view of a main part of the punching apparatus 3. FIG. 3 is a plan view of the main part of the punching apparatus 3.

As shown in FIGS. 2 and 3, the punching apparatus includes the punch unit 31, a lateral registration section 303 that moves the punch unit 31 and adjusts perforation positions with respect to a lateral shift of a sheet, and a pivotal registration section 304 that adjusts perforation positions with respect to a skew of a sheet.

The punch unit 31 includes plural punch heads 301A for perforating a sheet, a perforating section 310 in which the punch heads 301A are provided, and a driving section 305 that drives the punch heads 301A.

The perforating section 310 includes a supporting section 310A that supports the punch heads 301A and a receiving section 310B including holes for receiving edges of the punch heads 301A during punching.

Guides 311A and 311B that guide conveyance of a sheet are respectively attached to the supporting section 310A and the receiving section 310B of the perforating section 310.

The perforating section 310 includes a lateral end sensor 308 including a light emitting section and a light receiving section arranged to be opposed to each other across the guides 311A and 311B. The lateral end sensor 308 detects a sheet when the sheet passes between the light emitting section and the light receiving section.

The driving section 305 includes a lifting-and-lowering driving section 305A and a gear 305B and a slide link 301 that transmit the power of the lifting-and-lowering driving section 305A to the punch heads 301A. The slide link 301 includes a not-shown cam in the supporting section 310A.

In this embodiment, when the power of the lifting-and-lowering driving section 305A is transmitted to the slide link 301 via the gear 305B, the slide link 301 slides in a direction indicated by an arrow X3. The cam converts the power of a slide motion of the slide link 301 into a vertical motion of the punch heads 301A. The driving section 305 descends the punch heads 301A to perforate a sheet.

The driving section 305 can move integrally with the perforating section 310.

The lateral registration section 303 adjusts perforation positions with respect to a shift of the perforating section 310 in the width direction (hereinafter referred to as lateral direction) of the sheet orthogonal to the sheet conveying direction.

The lateral registration section 303 includes a lateral suspension member 312 attached to one end of the perforating section 310, a pinion gear 303B, and a lateral-registration driving section 303A, which is a stepping motor.

The lateral suspension member 312 includes a rack. The power of the lateral-registration driving section 303A is transmitted to the lateral suspension member 312 via the pinion gear 303B that meshes with the rack. The lateral suspension member 312 includes a lateral registration through-hole 302D, which is a through-hole long in the lateral direction. A lateral registration pin 302E fixed to a frame of the punch unit 31 is inserted through the lateral registration through-hole 302D.

The lateral registration section 303 includes a lateral registration actuator 302B and a lateral registration sensor 302C that detects a home position in the lateral direction of the perforating section 310.

When the lateral-registration driving section 303A is driven, the slide link 301 and the receiving section 310B are displaced in association with each other in the lateral direction indicated by an arrow X1 within a range of the length of the lateral registration through-hole 302D.

The pivotal registration section 304 includes a pivotal-registration driving section 304A, which is a stepping motor, a pivotal registration gear 304B, which is a gear that transmits the power of the pivotal-registration driving section 304A, a pivoting bar 304B3 and a pivotal registration actuator 304B4, which indicates a position of the receiving section 310B in a pivoting direction indicated by an arrow X2, provided in a last deceleration gear 304B1 of the pivotal registration gear 304B, a pivotal registration through-hole 302A, which is a through-hole long in a longitudinal direction of the receiving section 310B, and a pivotal registration sensor 304C that detects a home position in the pivoting direction of the receiving section 310B.

A pin 304B5 is provided in the pivoting bar 304B3. The pin 304B5 is inserted through the pivotal registration through-hole 302A.

When the pivotal-registration driving section 304A is driven, the slide link 301 and the receiving section 310B are displaced in association with each other in the pivoting direction along the sheet conveying direction indicated by an arrow X2 within a range of the length of the pivotal registration through-hole 302A.

The punch unit 31 includes plural lateral end sensors 308 that detect a lateral end of a sheet P to be conveyed, a passage sensor 309 that detects passage of the sheet P, a skew detecting section 307 including a first skew sensor 307A and a second skew sensor 307B arranged in two places in the receiving section 310B over the width direction orthogonal to a conveying direction of the sheet P, and an entrance detection sensor 314 that detects entrance of the sheet P.

A roller 306 and a roller driving section 306A that drives the roller 306 are arranged downstream in the sheet conveying direction of the punch unit 31.

The roller 306 passes the sheet P after perforation to the finishing apparatus 2.

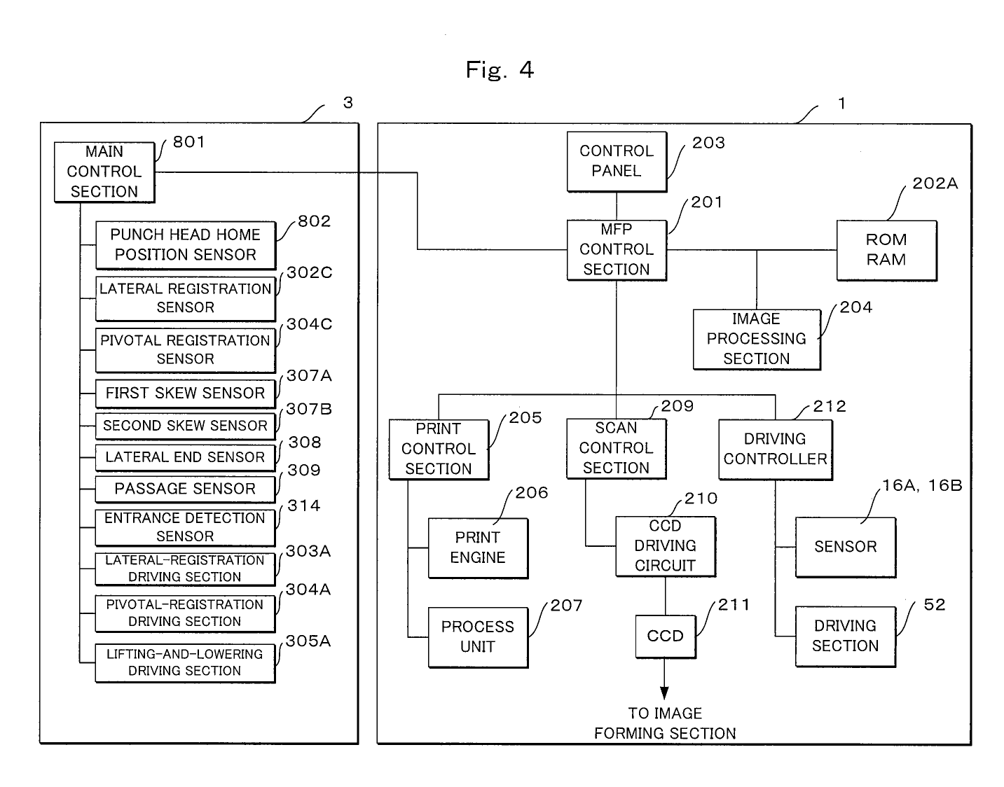

FIG. 4 is a block diagram of the configurations of the image forming apparatus 1 and the punching apparatus 3. As shown in FIG. 4, the image forming apparatus 1 includes an MFP control section 201, which is the control section 19 that collectively controls the entire image forming apparatus 1, a ROM and RAM 202A, which is a storage device, and an image processing section 204 that performs image processing.

The MFP control section 201 is connected to a print control section 205 that controls sections of an image forming system, a scan control section 209 that controls sections of an image reading system, and a driving controller 212 that controls the driving sections.

In the case of the electronic system, the print control section 205 controls a print engine 206 that forms an electrostatic latent image on the photoconductive drum 13B and a process unit 207 that forms a developer image.

The scan control section 209 controls a CCD driving circuit 210 that drives a CCD 211. A signal from the CCD 211 is output to the image forming section 13.

The MFP control section 201, the print control section 205, and the scan control section 209 include CPUs, which are arithmetic units.

The MFP control section 201 is connected to a main control section 801 that controls the punching apparatus 3.

The main control section 801 is connected to a punch head home position sensor 802 that detects a home position of the slide link 301, the lateral registration sensor 302C, the pivotal registration sensor 304C, the first skew sensor 307A, the second skew sensor 307B, the lateral end sensor 308, the passage sensor 309, and the entrance detection sensor 314. The main control section 801 receives inputs of outputs of the sensors.

The main control section 801 is connected to the lateral-registration driving section 303A, the pivotal-registration driving section 304A, and the lifting-and-lowering driving section 305A. The main control section 801 controls the operations of these driving sections.

The main control section 801 controls not only the operation of the punch unit 31 but also the operation of the finishing apparatus 2.

A control section of the finishing apparatus 2 may be configured to function as the main control section 801 and control the operation of the punch unit 31.

The main control section 801 of the punch unit 31 detects entrance speed of the sheet P from outputs of the entrance detection sensor 314 and the first skew sensor 307A or the second skew sensor 307B.

The main control section 801 detects the direction and the degree of a skew from outputs of the first skew sensor 307A and the second skew sensor 307B.

Specifically, if the second skew sensor 307B detects a skew earlier than the first skew sensor 307A, a control section of the punch unit 31 determines that the sheet P skews to the depth side. If the second skew sensor 307B detects a skew later than the first skew sensor 307A, the control section determines that the sheet skews to the front side. If the first skew sensor 307A and the second skew sensor 307B are simultaneously turned on, the control section determines that a skew does not occur.

If a skew occurs, the control section of the punch unit 31 detects the degree of the skew according to a difference between time when the first skew sensor 307A is turned on and time when the second skew sensor 307B is turned on.

### (I) The Punching Unit 31 Performs Punching

The control section of the punch unit 31 drives the pivotal-registration driving section 304A on the basis of the direction and the degree of the detected skew and displaces the pivoting bar 304B3 and the receiving section 310B to be parallel to the width direction of the sheet P.

The control section of the punch unit 31 selects the lateral end sensor 308 corresponding to the size of the sheet P. When the sheet P is conveyed to the punch unit 31, the control section of the punch unit 31 drives the lateral-registration driving section 303A and displaces the receiving section 310E until the lateral end of the sheet P is detected according to an output of the lateral end sensor 308.

The control section of the punch unit 31 displaces the receiving section 310B in the center direction of the sheet P on the basis of length set according to the sheet P from a position where the lateral end is detected.

The control section of the punch unit 31 drives the lifting-and-lowering section 305A and applies punching to the sheet P.

(II) The Punching Unit 31 does not Perform Punching

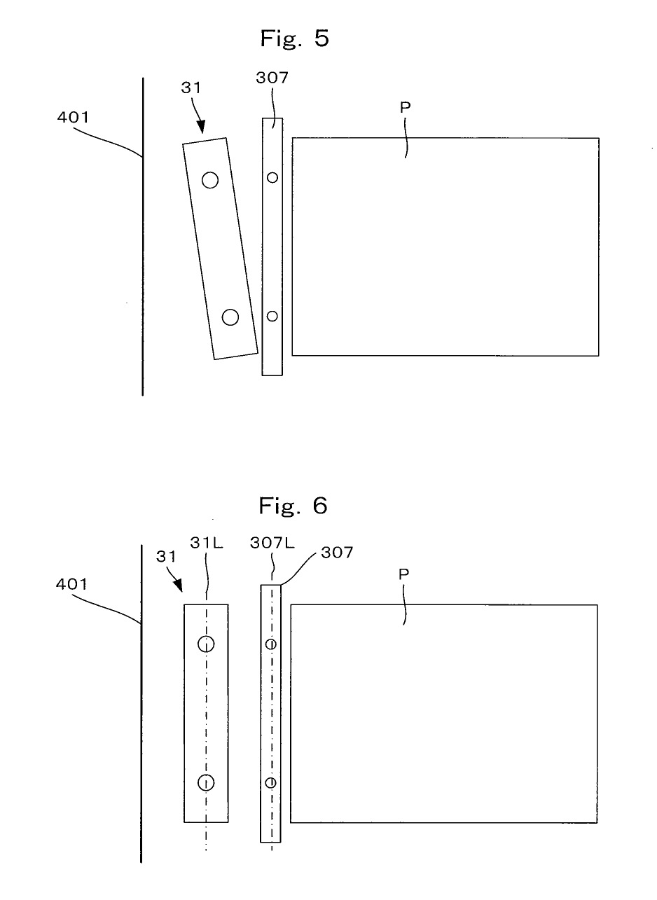

FIG. 5 is a diagram of a state in which the punch unit 31 is present in a home position. As shown in FIG. 5, the punching apparatus 3 includes an upstream conveyance guide arranged adjacent to the punch unit 31 upstream in the sheet conveying direction and functioning as a conveyance guide that regulates conveyance of the sheet P and a downstream conveyance guide set at an entrance to the punch unit 31 and the finishing apparatus 2.

In this embodiment, the punching apparatus 3 includes the skew detecting section 307 as the upstream conveyance guide. The upstream conveyance guide is not limited to the skew detecting section 307 and may be configured by a different member.

The punching apparatus 3 includes, as the downstream conveyance guide, a conveyance guide 401 set in the entrance to the punch unit 31 and the finishing apparatus 2. The downstream conveyance guide is not limited to the conveyance guide 401 and may be configured by a different member.

As shown in FIG. 5, a space between the skew detecting section 307, which is the upstream conveyance guide, and the punch unit 31 is narrow. However, a space between the punch unit 31 and the conveyance guide 401, which is the downstream conveyance guide, set in the entrance to the punch unit 31 is wide. Therefore, it is likely that the leading end of a curl of the sheet P enters this wide portion and a bend occurs.

(1) Conveying Speed of the Sheet P is Higher than a Threshold

FIG. 6 is a diagram of a position where the punch unit 31 is located when the conveying speed of the sheet P is higher than a threshold. As shown in FIG. 6, the control section of the punch unit 31 drives the pivotal-registration driving section 304A and displaces the punch unit 31 such that a width direction 307L of the skew detecting section 307, which is the conveyance guide rear end for the sheet P, and a center line 31L in the width direction of the punch unit 31 are parallel to each other. This position is referred to as a standby position.

Therefore, both a space between the skew detecting section 307, which is the conveyance guide rear end for the sheet P, and the punch unit 31 and a space between the punch unit 31 and the conveyance guide 401 set in the entrance to the punch unit 31 and the finishing apparatus 2 are the shortest.

Consequently, it is possible to minimize the likelihood of occurrence of a bend at the leading end of the curl of the sheet P.

(2) Conveying Speed of the Sheet P is Equal to or Lower than the Threshold

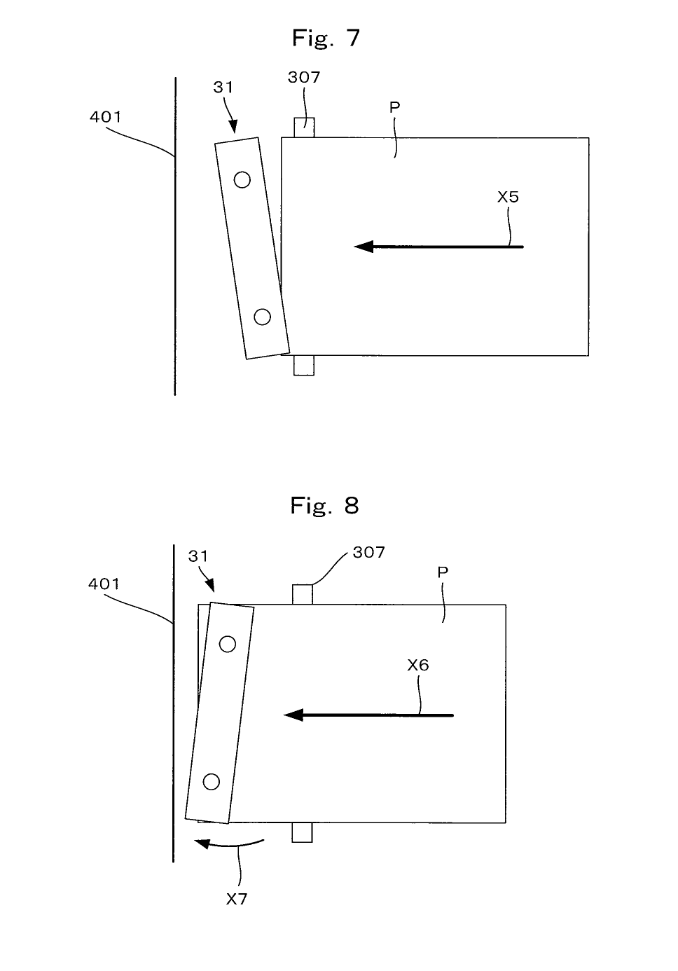

FIG. 7 is a diagram of a position where the punch unit 31 is located when the conveying speed of the sheet P is equal to or lower than the threshold. As shown in FIG. 7, the control section of the punch unit 31 puts the sheet P on standby in the home position until the leading end of the sheet P enters the inside of the punch unit 31. An arrow X5 indicates a traveling direction of the sheet P.

The control section of the punch unit 31 determines, from an output of the passage sensor 309 and the detected speed of the sheet P, whether the leading end of the sheet P enters the inside of the punch unit 31. This timing is set as default timing.

FIG. 8 is a diagram of a state of displacement of the punch unit 31. As shown in FIG. 8, the control section of the punch unit 31 drives the pivotal-registration driving section 304A according to the speed of the sheet P and pivots the punch unit 31 in a pivoting direction indicated by an arrow X7. An arrow X6 indicates a traveling direction of the sheet P.

An operation performed when a skew occurs in the sheet P is explained below.

If the sheet P skews to the front side, the control section of the punch unit 31 sets pivoting start timing later than the default timing.

If the sheet P skews to the depth side, the control section of the punch unit 31 sets the pivoting start timing earlier than the default timing.

A degree for setting the start timing earlier or later can be set on the basis of the degree of the skew.

Therefore, the leading end of the sheet P moves to a position closest to the conveyance guide 401 set at the entrance of the finishing apparatus 2 while being kept held by the punch unit 31. Consequently, it is possible to minimize the likelihood of occurrence of a bend at the leading end of the curl of the sheet P.

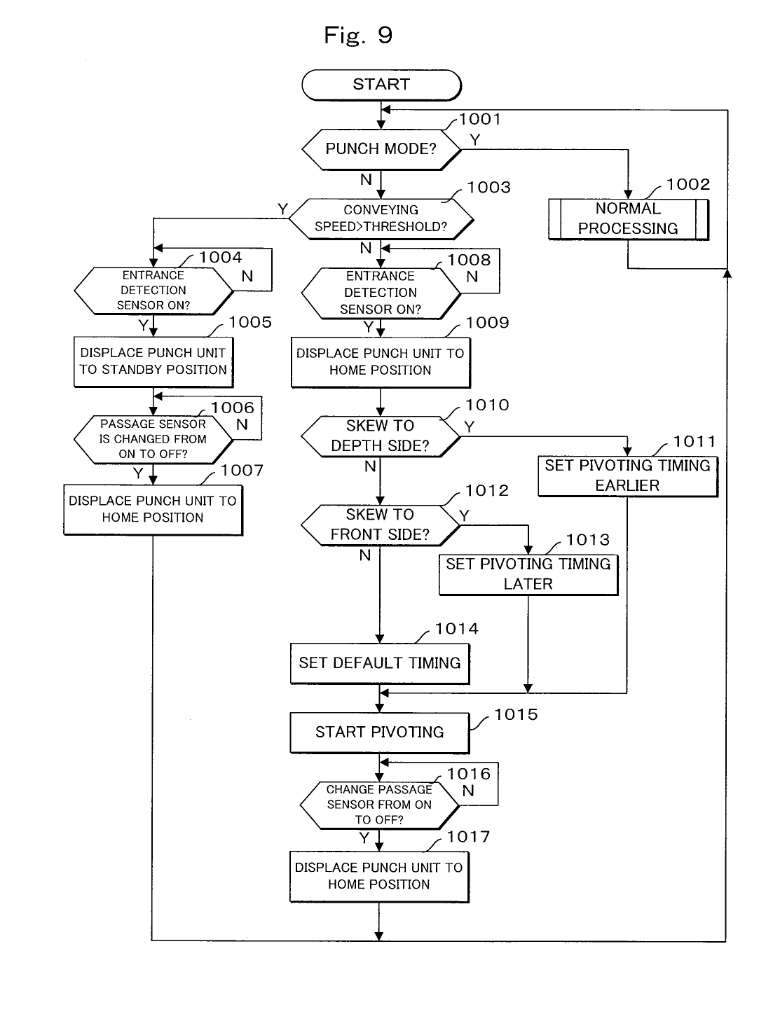

FIG. 9 is a flowchart for explaining the operation of the main control section 801 of the punching apparatus 3. As shown in FIG. 9, in Act 1001, the main control section 801 communicates with the image forming apparatus 1 and determines whether setting includes a punch mode.

If the main control section 801 determines that the setting includes the punch mode, the main control section 801 proceeds to Act 1002.

In Act 1002, the main control section 801 performs normal punching and returns to Act 1001.

On the other hand, if the main control section 801 determines that the setting does not include the punch mode, the main control section 801 proceeds to Act 1003.

In Act 1003, the main control section 801 determines whether the conveying speed of the sheet P exceeds the threshold. If the main control section 801 determines that the conveying speed exceeds the threshold, the main control section 801 proceeds to Act 1004. If the main control section 801 determines that the conveying speed is equal to or lower than the threshold, the main control section 801 proceeds to Act 1008.

If the main control section 801 determines that the conveying speed exceeds the threshold, in Act 1004, the main control section 801 determines whether the entrance detection sensor 314 is on. If the entrance detection sensor 314 is on, the main control section 801 proceeds to Act 1005. If the entrance detection sensor 314 is not on, the main control section 801 returns to Act 1004.

In Act 1005, the main control section 801 displaces the punch unit 31 to the standby position.

In Act 1006, the main control section 801 determines whether the passage sensor 309 changes from on to off. If the passage sensor 309 changes from on to off, the main control section 801 proceeds to Act 1007. If the passage sensor 309 does not change from on to off, the main control section 801 returns to Act 1006.

In Act 1007, the main control section 801 displaces the punch unit 31 to the home position and returns to Act 1001.

On the other hand, if the main control section 801 determines that the conveying speed is equal to or lower than the threshold, in Act 1008, the main control section 801 determines whether the entrance detection sensor 314 is on. If the main control section 801 determines that the entrance detection sensor 314 is on, the main control section 801 proceeds to Act 1009. If the main control section 801 does not determine that the entrance detection sensor 314 is on, the main control section 801 returns to Act 1008.

In Act 1009, the main control section 801 displaces the punch unit 31 to the home position.

In Act 1010, the main control section 801 determines whether the sheet P skews to the depth side. If the main control section 801 determines that the sheet P skews to the depth side, the main control section 801 proceeds to Act 1011. If the main control section 801 does not determine that the sheet P skews to the depth side, the main control section 801 proceeds to Act 1012.

If the main control section 801 determines that the sheet P skews to the depth side, in Act 1011, the main control section 801 sets pivoting timing earlier than the default timing and proceeds to Act 1015.

If the main control section 801 determines that the sheet P does not skew to the depth side, in Act 1012, the main control section 801 determines whether the sheet P skews to the front side.

If the main control section 801 determines that the sheet P skews to the front side, the main control section 801 proceeds to Act 1013. If the main control section 801 does not determine that the sheet P skews to the front side, the main control section 801 proceeds to Act 1014.

If the main control section 801 determines that the sheet P skews to the front side, in Act 1013, the main control section 801 sets the pivoting timing later than the default timing and proceeds to Act 1015.

If the main control section 801 does not determine that the sheet P skews to the front side, i.e., if a skew does not occur in the sheet P, in Act 1014, the main control section 801 sets the default timing as the pivoting timing.

In Act 1015, the main control section 801 starts pivoting of the punch unit 31 according to the set timing.

In Act 1016, the main control section 801 determines whether the passage sensor 309 changes from on to off. If the passage sensor 309 changes from on to off, the main control section 801 proceeds to Act 1017. If the passage sensor does not change from on to off, the main control section 801 returns to Act 1016.

In Act 1017, the main control section 801 displaces the punch unit 31 to the home position and returns to Act 1001.

As explained above, if the punching apparatus 3 according to this embodiment does not perform the punching action, the punching apparatus 3 moves the punch unit 31 from the home position to the position where the width direction 307L perpendicular to the sheet conveying direction of the skew detecting section 307, which is the conveyance guide rear end for the sheet P, and the center line 31L in the width direction of the punch unit 31 are parallel to each other and puts the punch unit 31 on standby.

Therefore, it is possible to minimize the space formed in the moving range of the punch unit 31 and prevent the sheet leading end from entering the space to cause a bend.

If the punching apparatus 3 according to this embodiment does not performing the punching action, the punching apparatus 3 displaces the punch unit 31 according to the movement of the sheet P.

If the conveying speed of the sheet P exceeds the threshold, the punching apparatus 3 according to this embodiment displaces the punch unit 31 such that the width direction 307L perpendicular to the sheet conveying direction of the skew detecting section 307, which is the conveyance guide rear end for the sheet P, and the center line 31L in the width direction of the punch unit 31 are parallel to each other. If the conveying speed of the sheet P is equal to or lower than the threshold, the punching apparatus 3 displaces the punch unit 31 according to the movement of the sheet P.

In other words, the punching apparatus 3 changes, according to the conveying speed of the sheet P, the operation of the punch unit 31 for preventing a bend from occurring in the sheet P.

Therefore, the punching apparatus 3 according to this embodiment can prevent a bend from occurring in the sheet P.

In this embodiment, the punching apparatus 3 that pivots the punch unit 31 along the conveying direction is explained. However, the punching apparatus 3 is not limited to this configuration. For example, the punching apparatus 3 may be configured to move the punch unit 31 in parallel to the conveying direction rather than pivoting the punch unit 31. In this case, the punching apparatus 3 may move the punch unit 31 from the upstream to the downstream according to the movement of the distal end of the sheet P such that the leading end of the conveyed sheet P does not enter the spaces between the punch unit and the upstream conveyance guide and downstream conveyance guide. The punching apparatus 3 may control the operation of the punch unit 31 for preventing a bend from occurring in the sheet P as explained above.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

What is claimed is:

1. A sheet processing apparatus comprising:
a punch unit including a punch head for perforating a sheet;
a driving unit configured to pivot the punch unit in a pivoting direction along a sheet conveying direction;
a conveyance guide arranged downstream in the sheet conveying direction of the punch unit and adjacent to a position for not preventing movement of the punch unit and configured to guide the sheet to be conveyed; and
a control section configured to move, if the sheet is not perforated, with the driving unit, the punch unit to a position where a center line in a width direction of the punch unit and a width direction of the conveyance guide are parallel to each other and put the punch unit on standby before the sheet is conveyed.

2. The apparatus according to claim 1, wherein
if the sheet is not perforated and if conveying speed of the sheet exceeds a threshold, the control section moves, with the driving unit, the punch unit to a position where the center line in the width direction of the punch unit and the width direction of the conveyance guide are parallel to each other and puts the punch unit on standby before the sheet is conveyed, and
if the conveying speed of the sheet does not exceed the threshold, the control section drives the driving unit to displace the punch unit according to movement of a leading end of the sheet.

3. The apparatus according to claim 2, wherein the driving unit is provided at one end of the punch unit and pivots the punch unit about the other end of the punch unit in the pivoting direction along the sheet conveying direction.

4. The apparatus according to claim 3, further comprising a detection sensor configured to detect a position of the punch unit, wherein
if the conveying speed of the sheet does not exceed the threshold, the control section detects the position of the punch unit with the detection sensor and pivots the punch unit to a downstream side in the sheet conveying direction according to the movement of the distal end of the conveyed sheet from a state in which the punch unit is pivoted to an upstream side in the sheet conveying direction.

5. The apparatus according to claim 4, further comprising a skew detection sensor arranged upstream the punch unit and configured to detect a skew of the sheet, wherein
if the conveying speed of the sheet does not exceed the threshold and if a skew occurs in the sheet, the control section detects the skew of the sheet with the skew detection sensor and changes timing for starting the pivoting of the punch unit with respect to timing for starting the pivoting when a skew does not occur in the sheet.

6. The apparatus according to claim 5, wherein, if the conveying speed of the sheet does not exceed the threshold and if a skew occurs on a depth side in the sheet, the control section controls the driving unit to set the timing for starting the pivoting of the punch unit earlier with respect to the timing for starting the pivoting when a skew does not occur in the sheet.

7. The apparatus according to claim 5, wherein, if the conveying speed of the sheet does not exceed the threshold and if a skew occurs on a front side in the sheet, the control section controls the driving unit to set the timing for starting the pivoting of the punch unit later with respect to the timing for starting the pivoting when a skew does not occur in the sheet.

8. A sheet processing apparatus comprising:
a punch unit including a punch head for perforating a sheet;
a driving unit configured to move the punch unit in a sheet conveying direction;
a first conveyance guide arranged upstream in the sheet conveying direction of the punch unit and adjacent to a position for not preventing the movement of the punch unit and configured to guide the sheet to be conveyed;
a second conveyance guide arranged downstream in the sheet conveying direction of the punch unit and adjacent to the position for not preventing the movement of the punch unit and configured to guide the sheet to be conveyed; and
a control section configured to drive, if the sheet is not perforated, the driving unit to move the punch unit to a standby position where a center line in a width direction of the punch unit and a width direction of the conveyance guide are parallel to each other and a space between the punch unit and the first conveyance guide and a space between the punch unit and the second conveyance guide are equal to each other.

9. The apparatus according to claim 8, wherein
if the punching is not perforated and if conveying speed of the sheet exceeds a threshold, the control section moves the punch unit to the standby position before the sheet is conveyed, and
if the conveying speed of the sheet does not exceed the threshold, the control section moves the punch unit with the driving unit according to movement of a leading end of the sheet.

10. The apparatus according to claim 9, further comprising a detection sensor configured to detect a position of the punch unit, wherein
if the conveying speed of the sheet does not exceed the threshold, the control section detects the position of the punch unit with the detection sensor and moves the punch unit further to a downstream side in the sheet conveying direction than the standby position according to the movement of the distal end of the conveyed sheet from a state in which the punch unit is moved further to an upstream side in the sheet conveying direction than the standby position.

11. The apparatus according to claim 10, wherein the driving unit is provided at one end of the punch unit and pivots the punch unit about the other end of the punch unit in a pivoting direction along the sheet conveying direction.

12. The apparatus according to claim 10, wherein the driving unit moves the punch unit in parallel to the sheet conveying direction.

13. A sheet conveying method comprising moving, if a sheet is not perforated, with a driving unit that pivots a punch unit including a punch head for perforating the sheet in a pivoting direction along a sheet conveying direction, the punch unit to a position where a center line in a width direction of the punch unit and a width direction of a conveyance guide are parallel to each other and putting the punch unit on standby before the sheet is conveyed.

14. The method according to claim 13, further comprising:
moving, if the sheet is not perforated and if conveying speed of the sheet exceeds a threshold, with the driving unit, the punch unit to a position where the center line in the width direction of the punch unit and the width direction of the conveyance guide are parallel to each other and putting the punch unit on standby before the sheet is conveyed; and
driving, if the conveying speed of the sheet does not exceed the threshold, the driving unit to displace the punch unit according to movement of a leading end of the sheet.

15. The method according to claim 13, wherein the driving unit is provided at one end of the punch unit and pivots the punch unit about the other end of the punch unit in a pivoting direction along the sheet conveying direction.

16. The method according to claim 15, further comprising detecting, if the conveying speed of the sheet does not exceed the threshold, a position of the punch unit with a detection sensor and pivoting the punch unit to a downstream side in the sheet conveying direction according to the movement of the distal end of the conveyed sheet from a state in which the punch unit is pivoted to an upstream side in the sheet conveying direction.

17. The method according to claim 16, further comprising detecting, if the conveying speed of the sheet does not exceed the threshold and if a skew occurs in the sheet, the skew of the sheet with a skew detection sensor and changing timing for starting the pivoting of the punch unit with respect to timing for starting the pivoting when a skew does not occur in the sheet.

18. The method according to claim 17, further comprising controlling, if the conveying speed of the sheet does not exceed the threshold and if a skew occurs on a depth side in the sheet, the driving unit to set the timing for starting the pivoting of the punch unit earlier with respect to the timing for starting the pivoting when a skew does not occur in the sheet.

19. The method according to claim 17, further comprising controlling, if the conveying speed of the sheet does not exceed the threshold and if a skew occurs on a front side in the sheet, the driving unit to set the timing for starting the pivoting of the punch unit later with respect to the timing for starting the pivoting when a skew does not occur in the sheet.
